(19) United States
(12) Patent Application Publication
(10) Pub. No.: US 2026/0260436 A1
(43) Pub. Date: Sep. 3, 2026

(54) CONVERGED MIXED REALITY (CMR): A LAYERED METADATA FRAMEWORK FOR MIXED REALITY ENHANCING WAYFINDING, NAVIGATION, AND COLLABORATION IN COMPLEX ENVIRONMENTS THROUGH TEXTURE SPACE ENCODING

(71) Applicant: Larry Clay Greunke, Seaside, CA (US)

(72) Inventor: Larry Clay Greunke, Seaside, CA (US)

(21) Appl. No.: 19/472,324

(22) PCT Filed: Mar. 18, 2024
(86) PCT No.: PCT/US2024/020466

§ 371 Date: Oct. 3, 2025

(51) Int. Cl. G06T 19/00; G06T 1/20; G06T 15/04; G06T 19/20

(52) U.S. Cl. CPC G06T 19/006; G06T 1/20; G06T 15/04; G06T 19/003; G06T 19/20; G06T 2210/52; G06T 2210/56; G06T 2219/2004

(57) ABSTRACT

A layered metadata framework for mixed reality, enhancing wayfinding, navigation, and collaboration in complex environments through texture space encoding. Converged Mixed Reality (CMR), is a layered metadata framework that facilitates the standardization of environment representation through “intelligence layers” accessible by both humans and machines. CMR can use custom encoding within colors for semantic understanding of complex systems. It is compatible with various geometric representations and enables efficient storage, visualization, and data utilization. When paired with mixed reality, it fosters improved communication and collaboration in applications such as autonomous navigation, object recognition, and maintenance of complex systems.

### CROSS-REFERENCE TO RELATED DOCUMENTS

This application claims priority to U.S. Provisional Patent Application No. 63/495,259, filed Apr. 10, 2023, and entitled “Converged Mixed Reality (CMR): A Layered Metadata Framework for Mixed Reality Enhancing Navigation and Collaboration in Complex Environments through Texture Space Encoding”, and to U.S. Provisional Application No. 63/497,716, filed Apr. 22, 2023, and entitled “Adaptive Mixed Reality Modeling System” both of which are hereby incorporated by reference as if fully set forth herein.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL FIELD

The present invention relates generally to artificial reality, mixed-reality technologies as applied to manufacturing, maintenance, entertainment, and other application domains requiring complex data layers and encoding synchronized to the real world.

### BACKGROUND OF THE INVENTION

This disclosure, and the exemplary embodiments described herein, described in The Converged Mixed Reality (CMR) framework is designed for comprehensive understanding and interaction within complex environments, emphasizing wayfinding, navigation, and orienting oneself. It introduces a system that utilizes “intelligence layers” or “metadata layers” for enhancing human and machine communication. This approach integrates various data representations, including digital twins and 3D models, into a unified platform for documentation, navigation, mixed reality environments, machine learning training, and human-machine collaboration. The framework seeks to improve efficiency, accuracy, and interoperability between humans and machines across diverse applications, making it a versatile tool for managing complex systems.

Human Background. Navigation has played a pivotal role in human exploration and understanding of the world. Throughout history, people have relied on knowledge, skills, and tools like maps, compasses, stars, and landmarks to navigate their surroundings. As our understanding expanded and technology advanced, navigation methods improved accordingly. GPS, for instance, revolutionized location tracking and route planning in open spaces, significantly enhancing our daily tasks and experiences. However, traditional navigation methods fall short when it comes to complex systems like buildings, ships, and aircraft.

Navigating intricate environments, such as indoor spaces or large structures, presents challenges due to factors like signal interference, attenuation, and multipath effects, which limit the effectiveness of GPS. Addressing these challenges calls for alternative approaches to navigation and communication within complex environments, spurring the exploration of advanced technologies and techniques. The proposed framework aims to provide the same experiential value that GPS offers but tailored to complex systems.

To navigate complex environments, humans have developed standardized languages, landmarks, and conventions, utilizing cognitive abilities like spatial reasoning and mental mapping. Furthermore, humans mentally attach various ideas, concepts, or metadata to the environments they interact with, creating a rich web of meanings and associations. This metadata is crucial for effective communication and collaboration among different individuals and groups working within the same environment.

The cognitive process of categorization allows humans to identify the defining features of objects, distinguish similarities and differences from other objects, and assign them to specific categories. Different individuals attach distinct meanings or associations to the same object based on their experiences, training, knowledge, and/or purpose resulting in a multidimensional understanding. People perceive environments differently. The reason GPS works so well for us is we are all communicating on the same construct, with locations on the Earth and applicable metadata. However, this approach fails in other coordinate systems and humans have to rely on their own knowledge and perception, making it entirely subjective.

For instance, in a commercial building maintained by various roles, a facility manager, security officer, and maintenance technician each perceive the building differently and attach unique ideas and understandings to it, creating a complex web of meanings and associations. This occurs even though they all reference the same physical object in the same space. Currently, no effective way exists to capture, store, and transfer this metadata for efficient communication and collaboration.

Machine Navigation Evolution. Machine navigation has rapidly evolved from direct human control to modern-day autonomy, paralleling human advancements in world exploration. Initially, manual control gave way to automated movements via simple programming, marking the advent of autonomous navigation systems. The late 20th century saw significant advancements with the development of advanced sensors and algorithms, setting the stage for today's sophisticated autonomous systems, such as self-driving cars. These vehicles, utilizing a combination of sensors, mapping data, and advanced algorithms, exemplify the progress in machine navigation, navigating roads and avoiding obstacles with remarkable accuracy. Incorporating GPS technology, autonomous systems have improved navigation capabilities in open environments where GPS signals are unobstructed. GPS provides essential data for route planning and positioning, aiding in the broader contextual understanding of the environment for autonomous vehicles. However, GPS has its limitations, particularly in indoor spaces or areas where the signal is obstructed, such as urban canyons, dense forests, or buildings and in spaces where the coordinate system moves, such as ships or aircraft. In these scenarios, machines rely on alternative navigation methods, including SLAM (Simultaneous Localization and Mapping), sensor fusion, and machine learning algorithms, to interpret and navigate complex environments. Establishing a universal understanding of the environment remains challenging, necessitating a blend of technologies to ensure accurate, reliable navigation and effective decision-making across diverse settings.

Computer Perception. The goal of enabling computers to perceive environments has largely relied on computer vision (CV) and machine learning (ML) algorithms, like YOLO (You Only Look Once), to interpret and interact with their surroundings. These technologies have significantly advanced, allowing machines to recognize objects and navigate spaces autonomously. However, they face challenges, notably in scalability and depth of understanding. CV and ML algorithms can identify objects such as “car” but struggle to provide detailed recognition, like identifying a “1995 Jeep Wrangler, SE Sport edition, with a 4.0L Straight Six engine.” This limitation reflects the broader challenge of achieving a nuanced understanding of complex environments, akin to human perception, which not only recognizes objects but understands their context, function, and significance in depth. This bottleneck in perception, driven by the current focus on broad object recognition rather than detailed understanding, underscores the need for advancing these technologies to capture and process richer environmental data.

Limitations of Present Geospatial Technologies. Machines mainly use 2D mapping representations like GeoTIFFs to understand and navigate environments. These files, which detail the coordinate system, geographic area, and data acquisition specifics, are vital for data interpretation and analysis.

However, representations such as GeoTIFFs, while proficient in 2D geographical data representation, fall short in capturing multidimensional real-world location details. Conventional 2D mapping struggles with locations like multi-story buildings or caves where the same latitude and longitude correspond to multiple distinct spatial entities.

GeoTIFFs also fall short in encoding rich semantic information, such as an object's function, properties, or relevant associations, which could be pivotal for different users or applications. For instance, in a hospital, an operating room's function, the specific equipment within, and the associated protocols aren't easily captured in traditional geospatial formats like GeoTIFF.

Such limitations pose significant challenges for machines that rely heavily on explicit data and struggle without direct representation of complex environmental information. While humans can often intuitively understand and navigate multidimensional environments, machines can't do the same due to the lack of rich, multi-layered mapping information. This drives the urgent need for advanced mapping representations encapsulating a more detailed and layered environmental view. Semantically encoding metadata in a space is more than just an exercise in “tagging”. The relationships between objects and artifacts, their function, and the fact that in some cases, the objects/artifacts themselves are complex systems, suggesting that a deeper, scalable solution for encoding metadata is needed.

Notably, these limitations also obstruct effective human communication about complex environments. Although humans have a remarkable ability to infer and intuit information, the absence of a shared, comprehensive, and detailed representation of environments can cause misunderstandings or inefficiencies. Thus, addressing these limitations is crucial not only for improving machine navigation and understanding but also for enhancing human-human and human-machine communication in various contexts.

Mixed reality. Mixed reality (MR), also known as hybrid reality, extended reality, spatial computing, or a host of other names coined by various companies' marketing teams, refers to the merging of real-world and virtual environments, creating a new form of reality. Blending elements of both virtual reality and augmented reality, mixed reality enables users to interact with digital objects within the real world and vice versa. Although often associated with gaming and entertainment, its potential applications span a wide range of fields, including education, training, healthcare, and engineering. Humans can easily understand and interact within mixed reality environments, and MR is currently viewed as a human-only experience.

Challenge. In our everyday interactions, each individual perceives and navigates the world in a way that is deeply influenced by their personal experiences, knowledge, and objectives, leading to a rich tapestry of subjective realities even within the same physical spaces. This inherent diversity in human perception presents a complex challenge when considering the collaboration and communication between humans and machines, including autonomous bots. Each entity, whether human or machine, processes information and stimuli according to its own unique set of experiences, knowledge, and designed purposes. A pivotal question arises: How can this varied information be encoded and communicated across different agents in a consistent, repeatable manner that enhances the efficiency of collective task execution?

This challenge is particularly acute in scenarios where precise and effective communication between humans and machines is essential. As autonomous machines become more prevalent in our daily lives, establishing a reliable method for human-machine interaction grows increasingly critical. The lack of such a method stands as a significant barrier, hindering not just collaboration but also the potential for mutual understanding and shared objectives within human-machine ecosystems.

The focus of this invention is to address these challenges, proposing novel solutions to bridge the communication gap not only between individual humans but also between humans and machines. By developing a system that standardizes the sharing and interpretation of information, the invention aims to facilitate a more harmonized and productive interaction within diverse teams of humans and machines, thereby unlocking new levels of efficiency and collaboration in executing complex tasks.

### DEFINITION OF TERMS

Complex system: Is defined as a sophisticated network of interrelated components that exhibit behaviors beyond the aggregate capabilities of their individual parts, characterized by significant intricacy and interconnectivity. These systems, often too chaotic for an individual to fully comprehend due to their extensive scale and dynamic interactions, span various domains and incorporate hierarchical structures with multiple subsystems, each operating under its own coordinate system and organizing principle. The integration of these subsystems, which may themselves be complex, necessitates a novel advanced mapping and data integration technique(s) to ensure consistent and coherent functionality and analysis across the entire system.
Intelligence layer: Constitutes a computational overlay integrated into a system or model to systematically enrich it with contextual, semantic, and operational insights, can also be referred to as a “metadata layer”. This layer, conceptualized as an abstraction, may be embedded within textures and aggregates information from a multitude of sources, encompassing both human-generated and algorithmically derived inputs. Its primary function is to act as a conduit between the foundational data and the end-user applications, thereby enabling a shared, consistent understanding among users. This collective comprehension facilitates enhanced analytical interpretation, interactive engagement, and informed decision-making processes within complex systems, underpinning the collaborative exploration and manipulation of said systems.
Texture: is defined as a logical mapping framework that correlates a spatial construct—whether a point, surface, area, volume, or object—with a corresponding texel (texture element). A texture may contain texels that represent varying sizes of spatial information, allowing for flexible and nuanced representation of complex environments. This adaptability enables the texture to accommodate uniform or non-uniform distribution of spatial information across different regions, facilitating detailed and dynamic environmental modeling. Hierarchical data management techniques, such as octree structures, further enhance this capability by organizing texels in a manner that reflects the spatial hierarchy and density of the represented information. Additionally, techniques like UV mapping can achieve variable spatial representation through the scaling of polygons, offering an alternative approach to hierarchical data structures. The concept of an “array” in this context refers to an organized collection of texels, which may span N dimensions. Importantly, the physical adjacency of texels in memory is not a requirement; the array can be traversed either directly or indirectly, ensuring flexible and efficient access to texel data for rendering or analysis purposes. This structure allows for the dynamic and detailed representation of information across various scales and dimensions.
Texel: A “texel,” or texture element, is defined as the fundamental unit of data within a texture, responsible for carrying detailed information corresponding to a specific spatial representation (i.e., point, surface, area, volume, or object). Each texel is capable of encapsulating a diverse range of data referred to as “fields”, from simple 1-bit flags to complex, abstracted quantities, represented through an N-bit structure. A texel may contain any non-negative real number of fields. This versatility allows texels to encode not only visual characteristics, such as color (e.g., red, blue, green, and alpha values) and brightness, but also multidimensional attributes that can include material properties, environmental conditions, or any contextual metadata relevant to the spatial domain it represents.
Field: In the context of data encoding and representation within complex systems, a “field” is defined as a subset of a data structure, specifically within a texel, designated for storing a discrete piece of information or a distinct attribute (referred to as a field “element”, see below). Characterized by its defined bit-length within the broader N-bit structure of a texel, each field determines the granularity and capacity of the data it encodes. Fields are employed to compartmentalize and organize data within a texel, enabling the encoding of varied types of information-from numerical values, enumerations, and binary flags to identifiers linking to extensive datasets. This organization facilitates structured and efficient encoding, access, and interpretation of complex data related to spatial elements, thereby enabling nuanced understanding and manipulation of attributes associated with specific points, surfaces, areas, or volumes in a modeled environment.
Field element: Within the structure of a field in data encoding, a “field element” refers to the smallest indivisible unit of information or attribute that the field is designed to encode or represent. Each field element, defined by the field's bit-length and the encoding schema employed, can encapsulate a variety of data types.

Discrete and Continuous Data Types include:
Integers: Whole numbers that can be positive, negative, or zero.
Enumerations: A set of named values that represent possible states or options.
Floating-point numbers: Numbers with fractional parts, used for precise calculations or representing continuous values.

Reference Types, serving as links or identifiers, include:
Pointers: Serve as references within a texel's field establishing links to other field elements or texels within intelligence layers, or to external databases and resources, facilitating direct access or relational connections.
Uniform Resource Identifiers (URIs): Standardized addresses used to identify or locate resources on the internet or within a network.
Handles: Unique identifiers used for managing access to objects or resources, valuable for security and networking purposes.

Unique Data Types for security and identification include:
Flags: Binary indicators used to represent the presence or absence of a condition or feature.
Timestamps: Records of specific instances in time, useful for versioning, logging, or temporal analysis.
Hashes: Fixed-size output from hashing functions, critical for data integrity checks, and cryptographic applications.
Unique Identifiers (UIDs): Distinct markers for uniquely identifying a texel or field element within the dataset, ensuring unambiguous identification and enhancing data navigability and integrity.
Security Keys (Public/Private Keys): Cryptographic keys essential for secure data transmission, authentication, and access control.

This allows field elements to serve as the building blocks for constructing detailed, multi-dimensional information that a texel carries, enabling precise and flexible representation of diverse attributes relevant to spatial domains, ranging from simple categorical data to complex continuous values.

### BRIEF SUMMARY OF THE INVENTION

Embodiments in accordance with the invention relate to a method and system for Converged Mixed Reality (CMR). In some embodiments, the method leverages a layered metadata framework to enhance the interaction and understanding between humans and machines within complex environments. The invention creates and utilizes 3D intelligence maps, termed “intelligence layers,” which can be stored in textures, facilitating seamless communication and collaboration across diverse systems. Each texel within the texture, as outlined in the definitions, is capable of mapping to a distinct spatial element, such as a point, surface, area, volume, or object. This mapping may correspond to various model representations, including but not limited to voxels, octree nodes, a mesh as a whole or part, points in a point cloud, or NURBS surfaces depending on the specific needs of the model. For convenience and understanding, the system will be mainly discussed through the use of encoding in textures as used in computer graphics today, but this is just an embodiment and should be considered non-limiting.

CMR is the innovative use of texture space within 3D representation of objects and scenes. This approach allows for the visual representation of semantic information, making it easier for both humans and machines to interpret and navigate the data. The system supports a wide range of geometric models or representations, from digital twins derived from Computer-Aided Design (CAD) models to Neural Radiance Fields, with the flexibility to apply intelligence layers to UV-mapped 3D models for various applications.

A significant advancement introduced by CMR is the encoding of intelligence layer information into textures. This method not only ensures a compact representation of data but also enhances security and privacy through bit reordering and encryption techniques. Furthermore, the inclusion of Octree textures supports efficient storage and management of 3D data, enabling quick access to intelligence layers and improving system scalability.

The ability of CMR to standardize language and understanding across different platforms marks a critical step forward in improving object detection and recognition, as well as machine learning capabilities. By providing a structured understanding of the environment, CMR serves as a pivotal reference for both humans and machines, aiding in understanding, navigation and interaction within complex settings.

CMR has implications within a mixed reality environment, where it bridges the gap between electronic machines and the human capacity to sense and reason. By having a machine being able to understand its position in a MR environment, it is able to leverage the knowledge that is encoded within it. CMR addresses the challenges posed by reliance on 2D representations or uncalibrated 3D models and parsing an entire understanding of the environment through computer vision algorithms thereby enhancing accuracy and efficiency.

The adoption of a common intelligence map, integrating multiple layers of metadata, offers a comprehensive solution to the limitations of traditional mapping technologies. This map not only facilitates a deeper understanding of the environment but also supports real-time updates and precise representations, thanks to techniques like SLAM and sophisticated sensor fusion methodologies.

As technology continues to evolve and integrate into our daily lives, the need for a shared understanding between humans and machines becomes increasingly critical. The development and implementation of a common intelligence map through CMR will revolutionize collaboration and communication in various fields, from urban planning, ship building, to day-to-day around the house by providing an efficient platform for sharing and storing metadata.

CMR represents a novel approach to creating and utilizing 3D intelligence maps, offering a powerful solution for enhancing interactions between humans and machines across diverse systems. By incorporating advanced technologies like Octree textures and layered bit encoding, CMR not only improves performance and scalability but also paves the way for significant advancements in environmental understanding and collaborative efforts.

### BRIEF DESCRIPTION OF THE DRAWINGS

FIG. 1 shows an example of a 32-bit schema for a Building Information Layer that can be used for encoding into an intelligence layer.

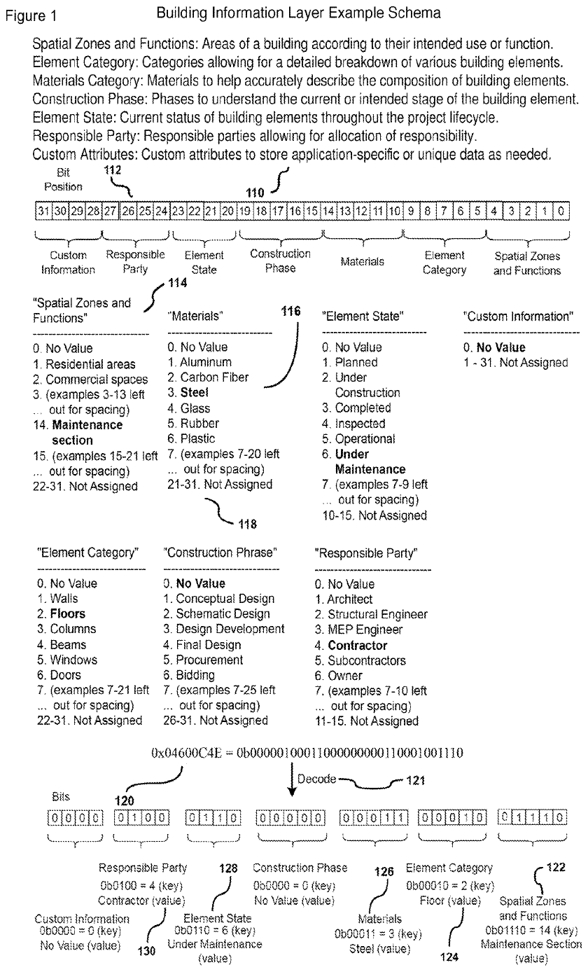

FIG. 2 shows the process for creating and applying data into an intelligence texture. The example uses a UV mapped 3D model.

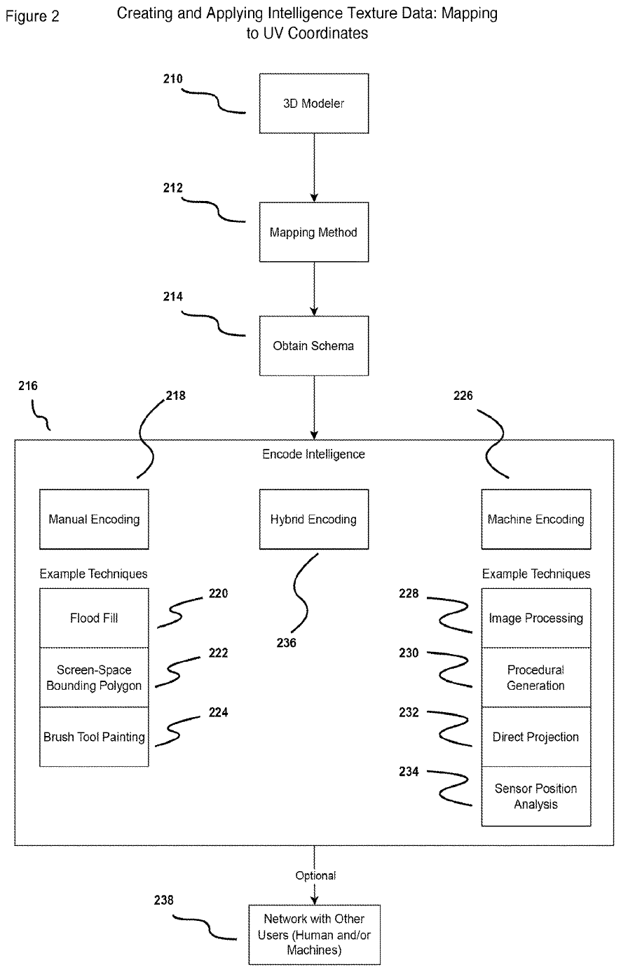

FIG. 3 shows an example of how to query a 3D model and return the schema data encoded into a specific texel.

FIG. 4 shows how to perform a semantic search through an intelligence texture layer and retrieve a related value.

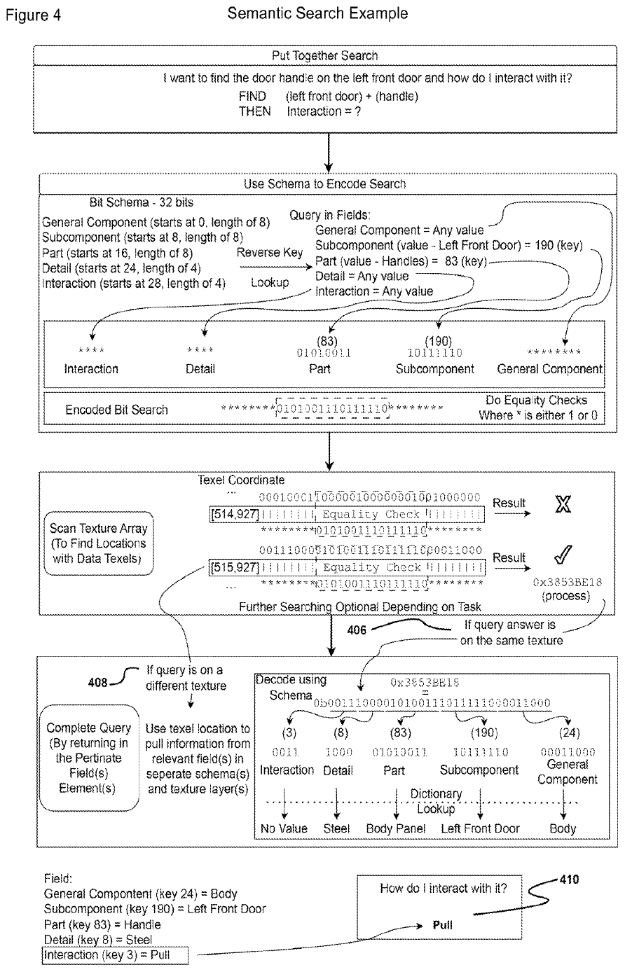

FIG. 5 shows how to use mixed reality to perform machine learning by leveraging spatial labeled data with CMR.

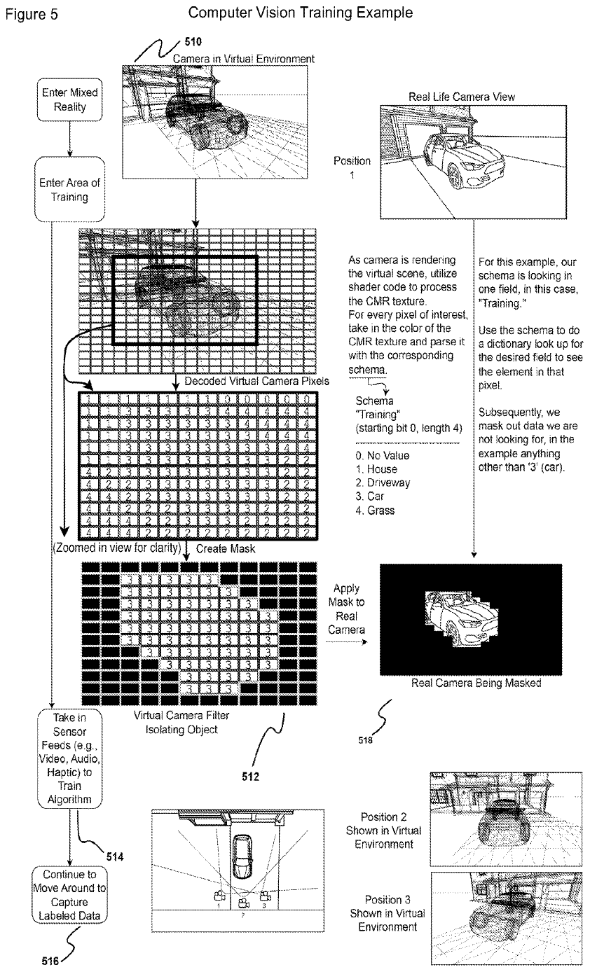

FIG. 6 shows how to perform spatial search by querying an intelligence texture and returning a location in 3D space.

FIG. 7 shows how to perform wayfinding and navigation through a physical space utilizing mixed reality and CMR intelligence layers.

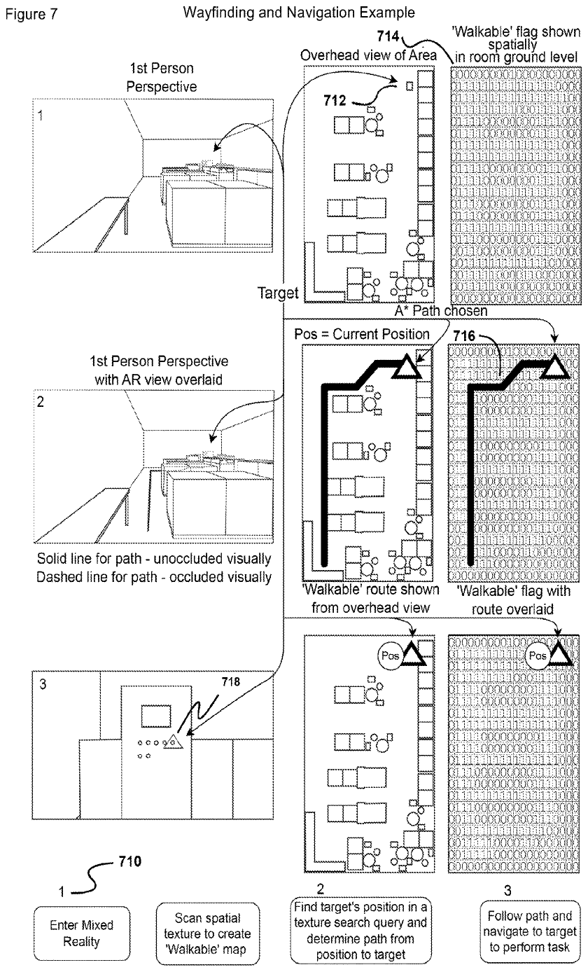

FIG. 8 shows how to join fields from different schemas with their respective textures into a composite schema and texture.

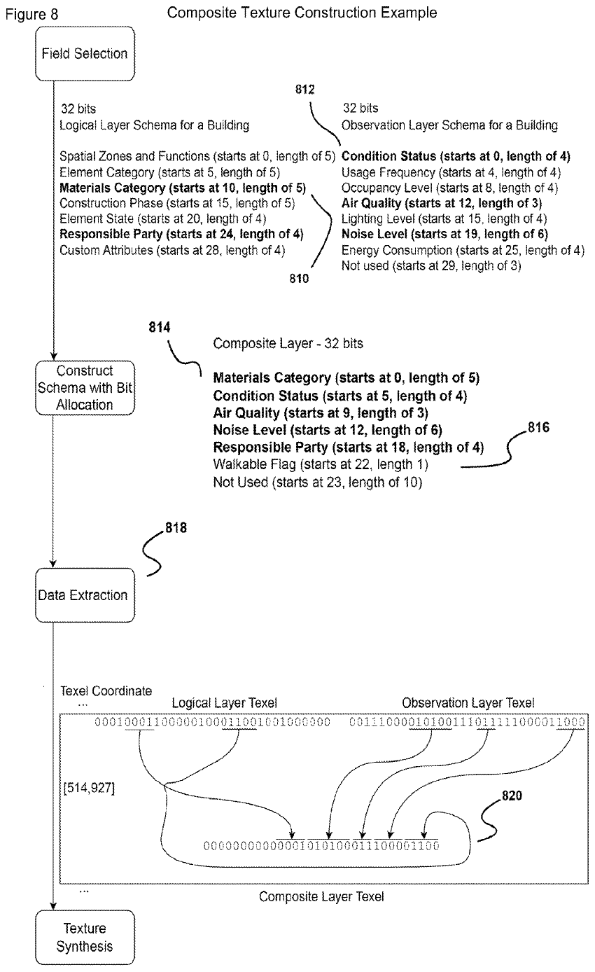

### DETAILED DESCRIPTION OF THE INVENTION

The present invention discloses Converged Mixed Reality (CMR), a layered metadata framework designed to enhance understanding and collaboration in complex environments and extend the capabilities of current geospatial technologies. CMR offers a standardized representation of the environment by creating and utilizing information-rich maps, termed “intelligence layers,” which can be generated by both humans and machines. This innovative framework is a versatile method for encoding data within textures mapped to 3D representations, transcending traditional texture mapping methodologies. The 3D representations referred to in this disclosure may be any form of 3D geometry or 3D coordinate space such that intelligence layer data can be coordinated with an object, surface, point in space, or any other 3D artifact. The term “3D geometry” is meant to refer to any 3D representation. These representations can be a point (e.g., point cloud), a surface area (e.g., area of a mesh), and a volume (e.g., volumetric segment within a 3D model or space defined for specific data encapsulation, such as the interior of a building or a machine part). CMR can exploit the full spectrum of available color space, this embodiment facilitates the encoding of colors in diverse formats, embodiments include, but not limited to, direct ties to points within a point cloud (e.g., in PTS format) and 2D arrays representing textures. Other embodiments leverage the use of UV mapping and Octree mapping techniques, distinguishing it from conventional practices. The invention is not specific to any one encoding method. Significantly, this encoding scheme is adeptly compatible with an array of geometric representations—ranging from digital twin CAD models of physical systems to geospatial datasets, and extending to Neural Radiance Fields, among others. This adaptability ensures the CMR framework's relevance across various domains, accommodating the evolving landscape of format technologies.

This comprehensive framework exemplifies versatility and innovation in leveraging color data encoding for a myriad of applications across diverse industries. It holds the potential to revolutionize autonomous navigation, object recognition, geospatial analysis, human-machine interactions, and the maintenance of complex systems through strategies such as Condition-Based Maintenance Plus (CBM+). At its core, the system fosters the creation and application of intelligence within texel data, enabling advanced capabilities like training and deploying machine learning models, conducting GPU-based parallel searches, and integrating with mixed reality environments for enhanced machine learning and identification purposes. Furthermore, it introduces a feedback loop, utilizing real-world sensor data for continuous learning and improvement. This ensures the texel data remains accurate, adaptable, and highly relevant across various practical applications. The subsequent sections will delve into each aspect of this process, offering a detailed exploration of the system's innovative embodiments and their transformative potential.

### The Structure of the Metadata Map for Uv Texture Space: Creating a Map Structure

In one embodiment, encodings that are stored in colors can be stored into the structure of a texture that is used commonly in computer graphics. These encodings may be logically separated to different textures or may be reduced to fit on a single texture. For ease of understanding, we will discuss them as separate textures. Each layer can have different encodings that can be performed and added as layers in a map. The types of layers can differ for the use case; for a non-limiting example, we will construct a few for a maintenance application. There are a couple layers that make sense as a starting point; we can think about this as humans as the way we categorize concepts. Multiple textures can be created, each containing different information or concepts, such as a naming system (allowing for more precise naming and references by humans), a texture to attach maintenance issues to specific locations, or any other relevant metadata that people or machines would want to store and recall about a system through layers. Encoding information into each layer involves deciding how to treat the number of bits available. The choice in the number of bits is left up to the implementation and current state of technology and is non-limiting, currently favoring a 32-bit standard for an optimal balance of storage efficiency and detail, allowing adaptability with technological advancements. As technology progresses and standards for creating textures evolve, this capacity can be adjusted, ensuring the system's adaptability to future enhancements without being constrained by current limitations.

One can treat the bits, 32-bits in our example, as flags, values, or some combination. For example, eight fields consisting of 1-bit each of the 32-bit total can represent eight independent items for ‘true’ or ‘false’ or if the 8 bits are combined into one field, a base two encoding would give 256 possible elements that could be represented. Ultimately, whatever the scheme of representation, the 32-bits will be stored as a color for each texel in the texture space. Multiple layers will have the same texel coordinates (each representing its own intelligence layer, e.g., naming, Building Information Modeling (BIM), or instrument reading from a sensor). Each texel coordinate that will map to an area on the surface of the model, enabling the user to get intelligence data of that spatial data. This approach facilitates the encoding of extensive information in a compact and efficient manner.

The process can be broken down into the following steps for encoding of BIM as an example:
Categorize Data: Categorize this data 110 to ensure that it can be efficiently encoded into the custom data structure. For the example of BIM data, begin by extracting relevant BIM data, such as component types, materials, and functional systems. In an example that is non-limiting, we'll use spatial zones and functions, element category, materials, construction phases, element states, responsible parties, and custom attributes. Determining the total number of elements in each list in base two format will indicate the necessary bit size for storage. For example, if we have 20 “spatial zones and functions,” that would take 5 bits to encode (4 bits can hold 16 values, but 5 bits holds 32 values).
Data Structure Assignment: Assign a group of bits or a “field” for each category within the 32 bits 112 to represent specific categories of information. All 32 bits do not need to be used at the time of creation, the structure can leave bits open or can assign values of zero for insertion of a new category or future growth of a category, if for example “spatial zones and functions” grows to 33 items, then it needs 6 bits to hold the list (5 bits holding 32 values will not contain it, but 6 bits holds up to 64 values).
Schema Creation: For each attribute or element, assign a value within the range represented by the assigned bits (a key-value pair) within a field 114. For the examples listed in the specification I will write them out the bits (base two) in human-readable form and not memory locations. For example, if you have 5 bits assigned for a “materials” category, you can represent 32 different individual materials with keys ranging from 0 to 31. For example, a key of “3” 116 or “00011” in binary within the 5-bit length field that starts at bit 10, has a value of “steel.” For personal preference, I use “0” as a special “No Value”, which will be the default in a texture until information is applied. For clarity, a field may be empty, and a texel may be empty, meaning that all fields for that texel are empty. For keys not used (e.g., 22-31 in Materials 118), they are not assigned but can be given values later allowing for growth. Bolded items in the lists within the figure show where the values are that have been decoded.

Intelligence Texture Creation: Following the establishment of a schema, such as one derived from BIM (Building Information Modeling), the next step involves crafting the intelligence texture. This process entails encoding specific values onto designated areas or components within the texture map, as detailed in the section on “Creating and Applying Intelligence Texture Data: Mapping to UV Coordinates.” To continue with the example and to illustrate, imagine we possess a 3D model of a building that has been UV unwrapped. Upon this model, we apply our data texture encoded with the BIM schema, thus integrating it into a 3D environment ready for interactive exploration. For instance, when examining the floor within a particular space of this model, we can perform a query by employing raycasting within the scene (car example 308). This action allows us to intersect the 3D model at a specific hit point (car example 310), from which we navigate to the corresponding UV coordinate (car example 312). At this juncture, we can access and extract data in the texel from the desired CMR layer—in our BIM example, the BIM layer-resulting in the retrieval of a specific value, such as 0x04600C4E 120. In another example that's visual, a car schema produces 0x0883BR18 314.
Decoding and Utilization: This crucial phase employs a decoding algorithm to unlock the meaning behind the intelligence texture, much like deciphering a secret code. Taking the example code 0x04600C4E, upon decoding 121, we discover that the examined spot within the model is designated as a “maintenance section” 122. It's identified as a “floor” 124 made of “steel” 126, currently flagged as “under maintenance” 128, with a “contractor” 130 noted as the responsible entity (the car example decodes in 316). From there, it is about utilizing that information for the user's task, which could be in a non-limiting list, analysis, or if in mixed reality, task execution and training.

This reveals a wealth of information that can be encapsulated within a single 32-bit color value. The flexibility of this approach is further enhanced through the ability to rearrange bits for more effective analysis. This ensures that the data's organization is tailored to meet both storage efficiency and analytical precision, showcasing the method's adaptability to various informational needs. By following this method, you can encode a large amount of information into an intelligence map using custom data structures that can be held and processed as a color, enabling efficient storage, visualization, and utilization of the encoded data in both texture space and 3D space. This versatility in encoding various types of information allows for more effective and streamlined communication and collaboration between humans and machines in a wide range of applications.

### Creating and Applying Intelligence Texture Data: Mapping to UV Coordinates

There are multiple organizational structures that can be used to map intelligence data to a 3D model, including UV coordinates, Octree structures, Bounding Volume Hierarchies (BVH), Voxel Grids, Sparse Voxel Octrees (SVOs), Point Clouds, and Neural Radiance Fields (NeRF) and texel to mesh mapping. It is possible to remap texture coordinates between different mapping methods as well, though some precision may be lost between structures. These methods allow for efficient encoding and decoding of metadata layers in large-scale, high-resolution 3D data. For the purposes of the discussion, UV coordinates will be explained. Further, the steps are described in a logical order for the reader, but the steps may occur at different times (e.g., a schema is created before a 3D model is obtained) and through different methods, so the description should be considered non-limiting.

There are numerous intelligence layers that can be generated and attached to a 3D model to facilitate effective human-human, human-machine, and machine-machine interactions. Layer examples include, but not limited to interaction layers, naming convention layers, object function layers, and safety information layers, among others.

3D Modeler and Periodic Updates: The initial step involves acquiring a 3D model of the target environment 210 or object using a variety of generation techniques. This encompasses the utilization of 3D scanning devices such as LiDAR, stereo vision cameras, structured light systems, Time-of-Flight (ToF) cameras, alongside advanced computational methods including photogrammetry, Multi-View Stereo (MVS), radar, sonar, Neural Radiance Fields (NeRF), and Gaussian splatting for point cloud data refinement. Beyond CAD models, which serve precise architectural or engineering purposes, 3D modeling programs like Blender provide versatile platforms for crafting detailed models.

Recognizing the dynamic nature of real-world environments, it's essential to periodically update these models to maintain their accuracy and relevance, akin to how GPS maps are updated to account for changes due to plate tectonics and construction. As physical changes occur within the environment or to the objects themselves, the corresponding 3D models require adjustments in their geometry. This could involve re-scanning the environment with updated technology or adjusting the CAD model to reflect new designs or structural changes. By ensuring these models are regularly updated, they remain accurate digital representations of their real-world counterparts, preserving their utility for applications ranging from navigation to simulation.

Mapping Methods and Texture Updating: Following the acquisition of the initial 3D model and recognizing the necessity for periodic updates, implement mapping methods appropriate to the model. Mapping serves as a way to connect the texel data to spatial locations (e.g., point, area, volume, or object) on the model. As an example, UV mapping will be discussed, but it should be considered non-limiting. For UV mapping, the map associates 2D texture coordinates (U and V) with the model's vertices, allowing for the application of 2D textures that visually represent the object accurately. UV mapping is one example where this method is applied, facilitating detailed and accurate textural representation on 3D surfaces. To ensure the model remains accurate and reflects real-world changes, regularly update the mappings.

Texture Intelligence Map Creation: Obtain desired coding schema 214 (Coding Schema), discussed in “The Structure of the Metadata Map for Texture Space: Creating a Map Structure” section. Combined with the 3D model with UV coordinates, we can create texture intelligence map(s) for the object in this example.

This next series of methods involves encoding intelligence elements or labels to different texels, regions, or components of the texture map 216 (Intelligence Encoder).

Manual Knowledge Encoding: This aspect of the invention involves a generic process where human expertise is leveraged to manually embed knowledge into the designated fields or layers of a 3D model, effectively creating an enriched intelligence map 218. The process capitalizes on the nuanced understanding and analytical skills of human experts to assign relevant and precise intelligence labels to various components, surfaces, or regions of the model. While this method may require substantial time and expertise, it typically yields highly accurate and detailed intelligence maps. The same approaches that are used in digital art applications can be used here. Non-limiting examples of techniques to facilitate this manual knowledge encoding include:
Spatial Selection and Data Flooding: An expert could select specific meshes or volumes within the 3D space, utilizing a flood-fill approach 220 to distribute intelligence data throughout the chosen fields efficiently.
Screen-Space Bounding Polygon: An example of this would be for a user on a conventional computer with a monitor, to create a screen-space bounding polygon 222 to encompass mesh triangles—particularly those with normals facing the viewer within a specified distance—serves as another method. This technique allows for targeted data embedding in parts of the model most visible or relevant to the user's current perspective.
Brush Tool Painting: Experts could use a virtual paintbrush tool to manually “paint” intelligence information directly onto the model's texture 224. This method mimics the act of painting in a 2D environment but applies it within the 3D model's context, allowing for granular control over the placement of intelligence data.

These examples are provided as non-limiting illustrations of the broader concept of manual knowledge encoding. They highlight potential tools and methodologies that could be employed within this framework but acknowledge that future innovations might introduce new methods for achieving similar outcomes. The invention's flexibility in accommodating various techniques ensures its adaptability and relevance in evolving technological landscapes.

Machine Create Knowledge Encoding: This method encompasses a generalized strategy for augmenting 3D models with intelligence layers through the application of various algorithmic techniques 226. The core objective is to systematically incorporate data into models in a way that enriches their informational value and utility, without being limited to specific methodologies. This process leverages algorithms capable of processing, analyzing, and embedding data based on distinct characteristics such as color, texture, or geometric patterns, as well as applying rules-based logic to auto-generate intelligence maps reflective of the model's or what the computer is perceiving the real world object's inherent structure and attributes. Non-limiting examples of techniques for algorithmic layer enhancement include:
Image Processing and Computer Vision: Utilizing these technologies to identify and segment model components, enabling the detailed marking of different areas based on visual input features 228.
Procedural Generation: Employing algorithms that define and apply intelligence layers based on the model's structural properties, such as identifying and labeling specific features within an industrial model based on geometry and CAD metadata 230.
Data Integration Techniques: This aspect of the invention aims to amalgamate a wide array of data streams onto the 3D model, thereby providing a dynamic update mechanism to the intelligence layers. The method is agnostic to the data's origin, supporting both real-world sensor data and simulated information to afford a versatile and comprehensive approach to model enhancement. Non-limiting examples of data integration techniques include:
Direct Projection: Projecting data, from either physical sensors or simulated sources, directly onto the 3D model 232. An example would be a thermal camera projecting heat data onto a relevant texture. This technique adjusts for alignment discrepancies between the data source and the model's geometry to ensure meaningful data overlays.
Sensor Position Analysis: Determining the precise spatial positioning and orientation of data sources to accurately interpret and integrate their outputs onto the model 234. An example of this is point measurements, such as ultrasonic testing meters where the point of measurement corresponds to a point on the 3D model and internet of things (IOT) where the sensor can be mapped to a specific spatial point or part. This method is adaptable to various data types, enriching the model with multi-dimensional context.

These examples are illustrative of the broader principles underpinning algorithmic layer enhancement and data integration techniques within the invention.

Hybrid Approach for Intelligence Map Creation: This approach is to synergize the efforts of humans and machines in crafting an intelligence map 236. To illustrate in non-limiting terms, we can apply manual annotation alongside machine learning-based segmentation. This fusion capitalizes on human expertise for detailed annotations and the computational power of machines for broad data analysis and initial field population within the texture maps. Specifically, generalist algorithms might first populate texture fields based on their programmed understanding, setting the stage for human experts to later review, validate, and refine these encodings for accuracy.

Furthermore, we consider the deployment of machines trained with specialized skills in analyzing and generating distinct texture and field entry types. These machines can collaborate directly with humans, who infuse the process with creative insight, oversight, and nuanced refinement. This collaborative method strikes a delicate balance, melding the rapid and scalable capabilities of automated systems with the nuanced understanding and adaptability of human input.

Such a cooperative approach aims to marry efficiency with precision, ensuring the development of intelligence maps of high quality. By allowing for both automated processes and human expertise, it enables a dynamic pathway to intelligence map creation, one that can adapt and evolve to include future methodologies and technologies, thereby maintaining the relevance and applicability of this approach in generating and refining intelligence maps swiftly and accurately.

Networking for Rapid Texture Mapping Creation: With the goal of swift content creation, CMR can leverage networking for texture maps 238. By connecting multiple users, encompassing both humans and machines, each possibly specializing in different aspects of texture authoring. This streamlined approach facilitates a collaborative environment where the unique strengths of diverse contributors are harnessed in concert to enhance the speed and quality of texture map development. Networking allows for the real-time sharing of updates and modifications, ensuring that all participants have access to the most current version of the texture map. It also allows for the efficient integration of contributions from various sources and the rapid validation of the texture maps produced. Human participants can quickly review and approve machine-generated textures, while machines can immediately apply human adjustments, creating a dynamic feedback loop that accelerates the entire process. At this stage, the model has been integrated with an intelligence map in texture space for the model that can be applied for relevant tasks.

### Aligning a 3D Model or Octree Structure With Metadata Map for Machine Navigation: Transferring Intelligence From Map to a Slam Derived Map

Building on the previous section, the following step-by-step procedure will guide you through aligning a 3D model or Octree structure with a metadata map for machine navigation, effectively transferring the intelligence from the map to a SLAM-derived map. This alignment process ensures that the machine can accurately navigate and interact with the environment using the intelligence-rich point cloud.

Prepare the 3D model or Octree structure: Ensure that the 3D model is UV-mapped and has an associated intelligence texture containing the relevant intelligence information encoded into color values. If you are using an Octree structure, ensure that it is built based on the 3D model and contains the intelligence information at each node.

Obtain the point cloud: Acquire the point cloud generated by the machine's SLAM (Simultaneous Localization and Mapping) process or any other applicable method. The point cloud should represent the environment or object the machine needs to navigate.

Estimate the initial alignment: Perform an initial alignment between the point cloud and the 3D model or Octree structure. This can be done using various registration techniques, such as Iterative Closest Point (ICP), Normal Distributions Transform (NDT), or other feature-based methods. This will provide an initial transformation matrix between the two datasets.

Refine the alignment: The goal is to minimize the difference between the point cloud and the 3D model or Octree structure by adjusting the transformation matrix. Iteratively refine the alignment between the point cloud and the 3D model or Octree structure using optimization algorithms, this can be done by different non-limiting methods such as Levenberg-Marquardt, gradient descent, or other suitable methods.

Project UV coordinates or Octree nodes: Once the alignment is satisfactory, project the UV coordinates from the 3D model's vertices or the Octree nodes onto the corresponding points in the point cloud. This can be done using a method like ray casting, nearest neighbor search, or other projection techniques.

Transfer and bake intelligence information: With the UV coordinates or Octree nodes projected onto the point cloud, look up the corresponding color values from the intelligence texture or Octree nodes. Transfer the intelligence information (color values) from the texture or Octree nodes to the associated points in the point cloud and “bake” the transferred color values onto the point cloud by storing the color values as attributes of the points in the point cloud or using a separate data structure that associates the color values with the points. This step effectively encodes the intelligence information into the point cloud itself.

Utilize the intelligence point cloud: With the intelligence information baked onto the point cloud, the machine can now utilize the color information in the point cloud for navigation, object recognition, or any other relevant tasks. The intelligence point cloud will provide a richer representation of the environment, enhancing the machine's ability to understand and interact with its surroundings.

By following these steps, you can create an intelligence point cloud that enables machines to effectively navigate, recognize objects, and perform other relevant tasks. This rich representation of the environment significantly enhances the machine's ability to understand and interact with its surroundings, paving the way for more effective and streamlined collaboration between humans and machines.

### Getting and Applying Intelligence Texture Data: Querying the Data in the Map

Introducing the crucial process of getting and applying intelligence texture data, this section outlines the necessary steps for effectively extracting and utilizing information from an intelligence texture map to aid tasks such as wayfinding, object recognition, or machine learning. The goal of this is to retrieve the appropriate texel(s) of interest, this can be done by multiple means, but in the example a raycast will be used to get the corresponding texel from a UV mapped texture and this approach should be considered non-limiting.

Obtain the 3D model: Acquire the 3D model of the object or environment you want to navigate, which should have an associated intelligence texture map or Octree structure.

UV-mapping (for intelligence texture): Ensure that the 3D model has a UV map, which establishes a correspondence between the 3D model's vertices and the 2D intelligence texture. This mapping allows for the projection of the texture onto the model's surface.

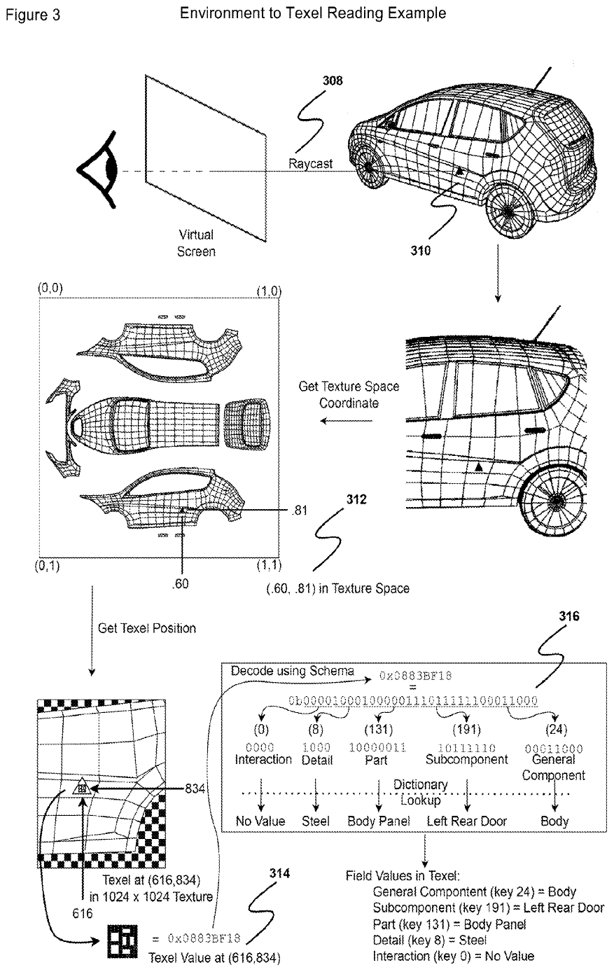

Identify the target position: Determine the target position on the 3D model that you want to access, either by using coordinates or other means of specifying the location. In FIG. 3, a raycast 308 is used to intercept the point of interest 310.

Retrieve the corresponding UV coordinates (for intelligence texture) or Octree node: Using the target position, find the corresponding UV coordinates on the UV map (for intelligence texture) 312 or the relevant Octree node (for Octree structure). These coordinates or nodes represent the location on the intelligence data source that corresponds to the target position on the 3D model.

Access the intelligence texture or Octree structure: Using the UV coordinates (for intelligence texture) or the Octree node (for Octree structure) obtained in the previous step, access the relevant data encoded in the intelligence source at that specific location 314. This data may include information about the object, its properties, or its context, depending on the structure of the intelligence map.

Interpret the data: Decode and interpret the retrieved data from the intelligence texture, utilizing the corresponding encoding schema 316.

Utilize the information: Apply the decoded information to the task at hand, whether it be navigation (work to get the 3D position in space from the UV coordinate on the object), object recognition (define the boundaries of the object that is desired based on the mapping) and create a boundary in screen space to focus the sensors on detection 512, machine learning, query how one would interact targeted object 410, or any other application that benefits from the intelligence mapping approach.

In conclusion, understanding and applying intelligence texture data or Octree structures (when relevant) is vital for enhancing human-machine interaction and collaboration within mixed reality environments. By following these steps, users can unlock the potential of intelligence mapping, leading to more accurate, efficient, and context-aware applications.

### GPU-based Parallel Search Using Intelligence Texture and Octree Mapping: Searching and Applying Intelligence in 3d Space

This section introduces GPU-based parallel search methodologies within 3D data structures, focusing on the application of intelligence texture and Octree mapping. It aims to elucidate how the power of parallel processing can be harnessed to effectively search and retrieve spatial positions of relevant data across diverse data structures. While the discourse primarily centers around intelligence texture searches, it's imperative to understand that the underlying principles and techniques are equally applicable to a broad spectrum of data structures, including but not limited to UV maps, point clouds, and more, for tasks such as navigation, object recognition, and machine learning enhancement. The mention of GPU-based approaches serves to highlight a specific embodiment; however, the utilization of CPU for parallel processing is also viable, underscoring the non-limiting nature of the discussed concepts.

Encode the search criteria: Define the search criteria based on the specific part or attribute of the object you want to find 610. Encode this information using the same bit value encoding technique used in the intelligence texture 612.

GPU parallel search setup: Set up a parallel search algorithm to run on the GPU. This may involve using a programming language like CUDA or OpenCL to leverage the GPU's parallel processing capabilities.

Load the intelligence texture: Upload the intelligence texture to the GPU memory, allowing the parallel search algorithm to access the data during the search process.

Parallel search execution: Execute the parallel search algorithm on the GPU, comparing the encoded search criteria with the information stored in the intelligence texture 614. The GPU's parallel processing capabilities will enable efficient and fast comparison of the search criteria against the entire dataset.

Retrieve search results: Collect the results of the parallel search, which can include the UV coordinates in the intelligence texture 616 or the reference for any other spatial representation that match the encoded search criteria. For straightforward searches aimed at uncovering additional data within field(s) of a specific texel, decode the pertinent value within that texel 406. When the information sought resides on a different layer, employ the texel's coordinates to decode the appropriate texture layer according to its schema, thus retrieving the targeted fields 408. To obtain the 3D position of the texel, proceed with the necessary steps.

Map UV coordinates to 3D model or traverse Octree structure: Using the UV map associated with the 3D model, convert the found UV coordinates back to their corresponding positions on the 3D model 618. For other spatial representations look up the corresponding spatial construct.

Extract the target object or part: With the positions identified on the 3D model or Octree structure, extract or highlight the specific part of the object that matches the search criteria 620.

Utilize the information: Apply the identified object or part to the task at hand, such as navigation 716, object recognition 512, machine learning, interaction method 410, or any other application that benefits from the intelligence mapping approach.

In summary, employing a GPU-based parallel search with intelligence texture can significantly improve the search efficiency and accuracy with human-machine teaming.

This approach harnesses the parallel processing capabilities of GPUs, ultimately resulting in faster and more precise identification of objects, parts, or attributes and contributing to better human-machine interactions.

### Mixed Reality Environment for Machine Learning and Identification: Additional Applications for Mixed Reality

AR headsets serve as a natural human-machine interface for various applications due to their immersive nature, which facilitates seamless collaboration between humans and machines by providing real-time visual feedback and contextual information. Beyond human navigation within complex systems and conventional machine learning for object recognition based on intelligence mapping, AR headsets can also enrich interaction intelligence maps by encoding additional information from user interactions with the environment or objects. The integration of intelligence mapping and interaction data allows AR headsets to deliver a more intuitive, context-aware, and efficient human-machine interface, supporting a wide range of applications and improving the overall user experience. The goal is to help the machine focus on where the object or portion of the object is for training utilizing mixed reality. The example is an embodiment of the process using labeled data with a UV mapped model in mixed reality and should be considered non limiting.

Outlined below is the process for machine learning-based object recognition and human interaction within a Mixed Reality (MR) environment using intelligence maps. However, the principles applied here are equally beneficial for humans, particularly in enhancing object recognition and understanding. Although the guide culminates at the point of using gathered data for machine learning, this could also help humans understand their settings.

Load the 3D model and intelligence map: Import the UV-mapped 3D model and its corresponding intelligence texture map into the mixed reality system, ensuring accurate encoding of intelligence information into the color values.

Calibrate the AR headset: Adjust the sensors on the AR headset, including cameras, depth sensors, and Inertial Measurement Units as required, for precise tracking and spatial awareness within the mixed reality environment.

Enter Mixed Reality: Align the 3D model with the real world 510. Use the headset's sensors, such as cameras or depth sensors, to estimate the transformation matrix between the real world and the 3D model through marker-based tracking, natural feature tracking, or other suitable registration methods. As a way to confirm alignment, the user can display the 3D model in the real world (making it opaque to the user) by viewing the registered 3D model in the mixed reality environment, ensuring that the intelligence information is properly presented.

Reference the intelligence map to focus on a specific field element for training: Utilize the intelligence map to direct the system's attention towards a particular object or region in the scene, allowing the system to concentrate on specific elements in the environment and optimize the learning process 512.

Collect sensor data: Capture real-world data 514 using the AR headset's sensors (e.g., visual, audio, tactile) while the user interacts with the environment 516. Continuously apply the training mask to highlight where the object is the subject of training 518. This data includes images, depth information, and sensor readings.

Process sensor data for feature extraction: Analyze the collected sensor data to derive relevant features and contextual information, which can be used for machine learning tasks such as object recognition, scene understanding, or task execution.

Train machine learning models: Leverage the extracted features and intelligence information from the overlaid 3D model to train machine learning models using supervised, unsupervised, or reinforcement learning techniques, depending on the specific task and desired outcomes.

Assess and fine-tune the models: Measure the trained machine learning models' performance with appropriate metrics and validation techniques. Refine the models by adjusting hyperparameters or incorporating additional training data, if necessary.

Implement the trained models: Deploy the optimized machine learning models to the AR headset or a connected device, enabling real-time object identification, labeling of new texture maps, and interaction within the mixed reality environment.

Update information and model: As needed, update and enhance the machine learning models as the user interacts with the environment and new sensor data is collected, ensuring improved performance and adaptation to changes in the environment or user interactions.

By following these steps, the intelligence layered mapped 3D model in the mixed reality environment can be effectively used for machine learning and identification tasks. This approach leverages the sensors on the augmented reality headset and provides a rich source of contextual information for learning algorithms. The integration of intelligence mapping and interaction data in a mixed reality environment not only enhances the machine's ability to recognize objects and understand the environment but also improves the overall user experience. This fosters more effective and streamlined collaboration between humans and machines, paving the way for innovative applications and advancements in the field of human-machine interaction.

### Enhanced Geospatial Resolution in Converged Mixed Reality (CMR) Through Texel-Based Earth Representation

The CMR framework elevates geospatial modeling capabilities by employing a texel-based approach to represent Earth's landscape. Imagine draping a globe with a highly detailed fabric, where each thread of the fabric corresponds to a specific geographic detail this visualization mirrors the application of 3D UV mapping in the CMR framework, although other ways could be implemented. Here, each texel acts like a thread in this fabric, aligned to represent precise locations on Earth's surface, thereby ensuring that geospatial data is both detailed and accurate. Unlike traditional mapping that might flatten these details into a two-dimensional plane, this method preserves the three-dimensional integrity of the data, allowing for a richer, more nuanced understanding of the geospatial domain. This approach not only retains the depth and complexity of the physical world in digital form but also expands the scope of geospatial information beyond mere surface mapping to include a fuller, more comprehensive representation of geographic locations.

The integration of latitude, longitude, and altitude data into each texel enables the CMR ecosystem to achieve a great level of precision in geospatial data representation. This facilitates detailed environmental modeling and accurate geolocation, essential for applications like terrain analysis, environmental conservation, and urban planning. Moreover, texel-based representation allows for precise positioning and rendering of 3D models in real-world locations, expanding the framework's utility for spatial analysis, including environmental simulations and disaster management strategies.

Mapping Models to Geographic Locations: This entails aligning 3D models with their real-world geographic counterparts, assigning lat-long coordinates to each model's origin point. This alignment ensures the virtual environment accurately mirrors the physical world, creating a faithful digital twin.

Creating Geospatially-Aware Intelligence Layers: Intelligence data can be encoded in geospatial intelligence layers that can map to the surface or volume usings textures. By map texels to specific Earth areas or volumes with lat-long coordinates, this facilitates precise digital twin city alignment with its real-world counterpart.

Integrating with Existing Geospatial Standards: The CMR framework's also support standards such as GML (Geography Markup Language) and KML (Keyhole Markup Language) data to be coded into schemas, allowing for interoperability with existing systems. Utilizing GPS and geospatial databases enables the identification of objects' geographical locations and enriches the intelligence layers with dynamic, multi-dimensional data.

Enriching Geospatial Protocols with Semantic Information: Beyond latitude, longitude, and altitude, incorporating semantic information into geospatial protocols offers a comprehensive understanding of the environment. This process involves extracting and synthesizing data from GIS databases, satellite images, and LiDAR scans, and enriching it with details from public and private databases. Such databases may include business locations, custom points of interest (POIs), and other relevant semantic data, all tied to precise geographic coordinates. By encoding this enriched data into intelligence layers and integrating it with existing geospatial protocols, we significantly enhance the capabilities of machine learning applications, autonomous navigation, and predictive modeling. This approach is supported by a continuous update and feedback loop, ensuring the relevance and accuracy of the geospatial data. The integration of semantic geospatial data, therefore, not only improves environmental mapping but also makes this information actionable for various user applications, ranging from commercial services discovery to urban planning and environmental monitoring.

In conclusion, by merging texel-based earth representation with semantic information integration, the CMR framework not only enhances spatial accuracy and detail but also broadens its application across various industries. This innovative approach offers a sophisticated tool for environmental understanding, urban planning, and more, paving the way for advancements in geospatial intelligence.

### Advanced Texture Database System: Enhancing Resolution and Precision Through Dynamic Scaling

The Advanced Texture Database System within the Converged Mixed Reality framework introduces a scalable approach to texture resolution, significantly enhancing the precision and detail of 3D models by dynamically adjusting the texture size. This system is structured to support a multi-layered approach, integrating various types of data layers-such as logical, observation, analysis, and interaction layers-with the flexibility to increase texture resolution where necessary. By doubling the length and width of textures in targeted areas, the system can achieve higher precision, allowing for detailed visualization in regions of particular interest while maintaining efficiency across the model.

Advanced Texture Database System has the ability to dynamically adjust texture resolutions based on specific requirements. This means that for areas requiring higher detail—such as around locations that usually see higher maintenance actions (e.g., stress joints on vehicle frames) can increase the texture resolution, enhancing the detail and clarity of these areas. One embodiment to achieve this is by doubling the texture's dimensions, effectively quadrupling its detail level, thereby allowing for a greater level of precision in texture mapping. Other methods, such as Octrees can do this by creating more nodes.

The database structure can be designed to accommodate the complexity and diversity of data layers associated with 3D models. It encompasses different layers, and can include, but not limited to:
Logical Layers: Define the basic structure and relationships within the data. This layer houses the underpinning information such as naming conventions, purpose, function, classification, physical properties, logical connections, and system architectures, thereby crafting a standardized language and serving as the foundation for further detail and analysis.
Observation Layers: Can contain raw or processed data collected from various sources, providing a detailed account of the physical characteristics and conditions of the model such as sensor readings and environmental data.
Analysis Layers: This layer facilitates predictive analyses, semantic annotations, behavioral analyses, and optimization analyses. By employing advanced AI algorithms and human expertise, this layer accentuates the potential of the raw data, rendering it into a powerful tool for informed decision-making and strategic planning.
Interaction Layers: These layers are designed to enhance how users engage with both digital and real-world systems. In real-time environments, they help users navigate interactions, such as identifying actionable elements like handles (410 and 620) or buttons 718 and understanding operational gestures, such as turning an object. Within virtual environments, these layers guide interactions with digital models, specifying methods for interaction detection, including eye gaze, touch, and gestures, focusing on specific model areas.
Historical Layers: Capture the chronological development or changes of the model or its components over time. This can include versioning information, documents IDs associated with locations in time, modification history, and evolution of design concepts, providing a temporal dimension to the data.
Security Layers: Designed to incorporate access control, encryption, and other security protocols directly into the data architecture. This layer embedded within the 3D model protects against unauthorized access and manipulation.
Customization Layers: Allow for the personalization of models according to user preferences or specific requirements. This layer can include user-defined settings, alternative designs, or configuration options that adapt the model for different uses or visualizations.
Composite Layers: These layers amalgamate selected fields from any of the aforementioned layers, including Logical, Observation, Analysis, Interaction, Historical, Security, and Customization. By integrating fields across different dimensions of data, composite layers offer a holistic representation of the model, tailored to specific analysis, visualization, or interaction needs. They enable users and systems to access a consolidated dataset that reflects both the macro and micro aspects of the model, facilitating complex analyses and interactions that require data from multiple perspectives.

Each layer is associated with texture data that can be dynamically scaled in resolution, ensuring that the visual representation remains consistent with the level of detail required by the data it represents. This structure not only supports the efficient storage and retrieval of high-resolution textures but also ensures that the application of these textures to 3D models is both accurate and resource-effective.

### Enhanced Navigation and Interaction in Mixed Reality Environments

Enhanced navigation and interaction in mixed reality environments explores the versatile method leveraging the Converged Mixed Reality (CMR) framework for both identifying objects and executing tasks upon them. Spanning a variety of tasks from identification and navigation to recognition and task performance, this method is applicable to tasks assigned and executed by humans and machines alike. Highlighting the CMR framework's utility, we examine its use for navigating to and interacting with a specified task, such as pushing a “Reset” button. This example demonstrates the framework's broad applicability, noting that actions and requirements may vary based on task nature and execution entity and the description should be considered non-limiting.

Setting the Stage for Interactive Navigation: Establishing a mixed reality environment aligns the digital representation with the physical world, ensuring accurate interaction with entities across both realms 710. By syncing the virtual and physical perspectives through sensor alignment, users and machines gain a unified view, facilitating precise item targeting within 3D space. Additionally, CMR's task management capabilities, introduced at this stage, emphasize the framework's ability to dynamically manage tasks-marking and guiding users or machines to their completion based on real-time data and layered intelligence insights.

Dynamic Task Management and Execution: Identifying issues and assigning tasks within CMR can be both centralized and flexible, allowing for proactive and adaptive task management. Whether tasks are determined through manual inspection or automated environmental scanning (e.g., internet of things), CMR's intelligence layers play a role in spotting issues and aligning tasks with user capabilities and location. This dual approach of direct system assignment and real-time, navigational discovery ensures efficient task management, paving the way for effective execution. As users embark on navigation, enriched by CMR's detailed environmental understanding, they're guided not just towards locations but through the interactive completion of tasks, culminating in the targeted engagement with specified objects and the fulfillment of associated actions.

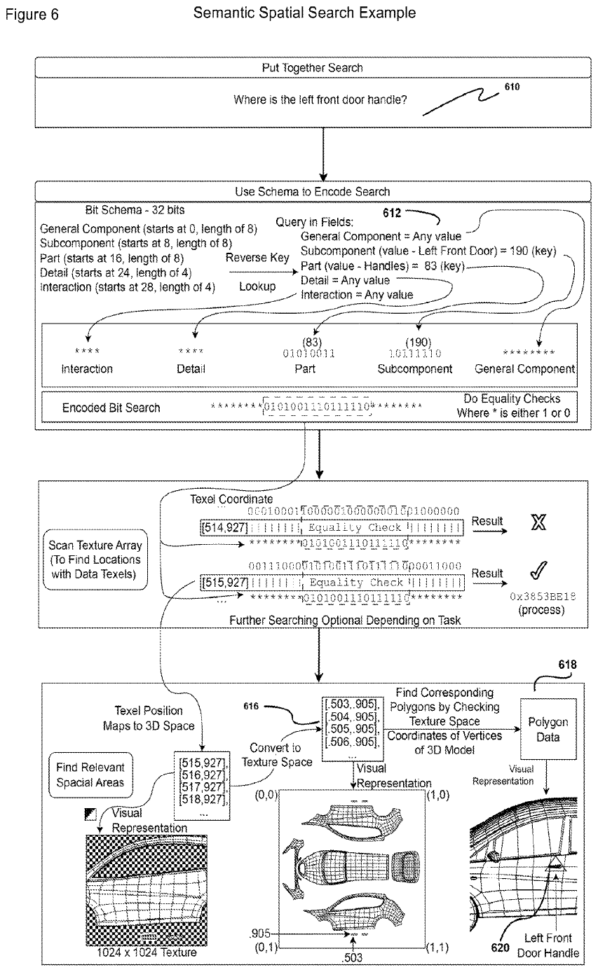

In practical terms, this could mean that upon detecting a malfunctioning piece of machinery through sensor data integrated into the CMR intelligence layers—for this example, a button that requires resetting—the system might automatically delegate a maintenance task to the closest qualified technician or machine. This assignment includes detailed information on the equipment's location and the repair steps. Conversely, utilizing a more decentralized method, the system may present maintenance tasks to users as they move within an industrial setting. These tasks are aligned with their capabilities and available tools, identified through an ongoing analysis of their locations and the intelligence layers of their surroundings. Here, the discussion proceeds with an example where the system assigns a task.
Locating the Target Item in 3D Space: As the user, once an assignment has been given utilize the CMR framework to dynamically identify the target item within the 3D environment 712. This involves querying the intelligence texture data or other structured representations like UV maps, where items are identified within color representations as previously discussed. The search is facilitated by accessing the data structures that map these color representations to their corresponding positions in the 3D space as shown in FIG. 6. This step is not only for finding the item but also can be used for identifying any associated tasks that may be marked for completion in the vicinity of the item that is in the task queue.
Create or Load Navigation Map: Create or use a navigational map by scanning an appropriate field, in the example a boolean flag of if a spatial volume is walkable or not 714. When creating or using a navigation map, the system can not only assess walkability but can also consider task locations and priorities within the environment. The map can dynamically update to reflect new tasks or changes in the environment.
Navigating Towards the Designated Target: Utilizing a search algorithm, like A* search, this approach charts a pathway from the current position of either a human or machine to the designated object 716. The intelligence layers' detailed labeling within the CMR's 3D models guides the most practical route, avoiding obstacles and optimizing for environmental features. This navigation process is enhanced by the system's ability to dynamically highlight tasks needing attention along the route, allowing for efficient task planning and execution. For humans, a path could be found by connecting ‘walkable’ labels in a field such as environmental data, ensuring a safe and efficient journey. Similarly, for machines, particularly in autonomous driving contexts, a path could be chosen that optimizes safety and efficiency from field labels. These approaches can take into account the labeled characteristics of the terrain, whether navigating outdoors or indoors. As navigation proceeds, augmented reality interfaces (such as sound, vision, and haptics) can introduce humans to additional points of interest identified by CMR labels, or an integrated machine vision system for machines, thereby enriching situational awareness and interaction with the environment.

Isolating the Target Item Using the Virtual Camera: As the virtual camera renders the environment, isolate the target item, in this case, a “Reset” button, based on its pixel representation within the graphics pipeline being parsed by the schema. This step involves, in this embodiment, identifying which pixels in the virtual camera feed correspond to the target item, thereby facilitating its isolation in the physical world 718. This identification process not only isolates the item but also goes towards understanding any related tasks, as indicated by the method of interaction field within the texels.

Perform Task: With the target now isolated in view, and distance known, the user (human or machine) could look up in a method of interaction field within the texels for the object, and see “push.” This step signifies the direct application of task completion, where the location and interaction methods have been clearly defined, allowing the user or machine to perform the task efficiently.

By following these steps, users can navigate to specific locations in the world and utilize mixed reality to interact with items in their environment. This method leverages the strengths of CMR to enhance machine learning capabilities, making it possible for machines to better understand and navigate complex environments.

### Enhanced Data Efficiency in CMR Through Texture Synthesis and Dynamic Field Remapping

The Converged Mixed Reality framework also enables multi-layer field alignment and dynamic texture synthesis, aimed at merging multi-disciplinary data into a cohesive texture. This system combines discrete fields from multiple schemas and their associated data layers, such as logical and observation layers, into a unified 32-bit structured texture, dynamically constructed at runtime. The choice of 32-bits as described earlier, currently represents a good tradeoff of size and performance by today's standards and fits well with textures used in computer graphics today and should be considered non-limiting. By extracting and integrating specific bit-fields from different schemas and textures across multiple layers, it crafts a composite schema and texture rich in information, precisely tailored to application requirements. This process aims to integrate fields of interest, which may be ephemeral or intended for long-term use, and is exemplified here as an on-demand operation, though this method is non limiting. Furthermore, this process includes the capability to streamline larger schemas by extracting only the pertinent fields, enabling the creation of a more compact schema from a larger 64-bit schema to fit within a 32-bit framework for example, demonstrating the system's flexibility and efficiency.”

System Overview. The system's functionality revolves around dynamically combining fields from diverse data sources into one or more texture maps from different schemas. For example, it can integrate fields of 5 and 4 bits from a logical layer schema 810 and texture with fields of 3, 4, and 6 bits from an observation layer schema 812 and texture. This alignment and combination process is executed dynamically, creating a blended schema to read the created bit structure, enabling the real-time generation of a new texture filled with rich, relevant information.

Dynamic Texture Construction unfolds through several steps:
Field Selection: Identifies specific fields from across layers, representing key information like material properties or environmental data.
Construct Schema with Bit Allocation: Assigns each field a portion of the 32-bit structure, ensuring the total bit count remains within limits 814. Furthermore, fields can be dynamically defined, such as introducing a flag to indicate whether a location is navigable 816.
Data Extraction: Relevant texels are scanned to extract designated fields from their textures during runtime 818. Logical operations can be applied to populate these fields effectively; for instance, if a field contains a singular element, an equality check can be utilized to set a flag as needed.
Texture Synthesis: Aligns and merges extracted fields into a unified 32-bit structure, creating the composite texture 820.
Visualization: The texture can now be visualized on the 3D models, offering a visual that integrates the data fields for intuitive interpretation and interaction.

Dynamic Field Remapping for Enhanced Data Compression Another feature within the CMR framework is the system's dynamic field remapping capability, significantly optimizing data compression and efficiency. It supports using original field sizes or generating derivative mappings for subsets of the original schemas. For example, if a user is interested in only 6 out of 32 materials in a field within a schema, originally encoded in 5 bits, these can be remapped to a compressed 3-bit representation for a new schema. Additionally, if multiple categories that are mutually exclusive, or mapped in a way to catch all the necessary permutations they can be joined into a single field. This greatly enhances data compression by minimizing the bit requirement for the selected dataset.

This embodiment in the CMR framework concentrates on efficiency and clarity in combining and visualizing complex information sets, focusing on dynamic field remapping for improved data compression. It supports a broad spectrum of applications by enabling detailed analysis and representation of selective data, ensuring performance and usability enhancements.

### Benefits of Bit Encoding for Layers and Having Different Layers that Users can Access

1. Security: Bit encoding and encryption can help protect sensitive information from unauthorized access. One could use bits that are not in order and process them by putting them together (e.g., bits 1,14,8,9,23 instead of 5 bits in a row). One could embed the sequence within a traditional diffuse texture of a 3D model for example in a video game for example. If done on bits that have little effect on the color, it would not be easy to discern that there is additional information encoded into the texture.
2. Customization: Different layers allow users to tailor their view and interactions based on their specific needs.
3. Scalability: Separating information into layers allows the system to scale more easily as new data and features are added.
4. Modularity: Encoded layers enable easier integration with other systems or third-party applications.
5. Access control: Granting different access levels to different layers enables a more granular approach to information access.
6. Reduced complexity: Users can focus on the information most relevant to their task, rather than being overwhelmed by a single, complex layer.
7. Easier maintenance: Separating information into layers makes it simpler to update, modify, or remove specific data.
8. Improved performance: Having multiple layers can lead to better performance, as users only load the data they need.
9. Data integrity: Bit encoding can help maintain data integrity by ensuring that information is stored and transmitted accurately.
10. Collaboration: Different layers allow multiple users to work on various aspects of the model simultaneously.
11. Version control: Using separate layers can help track changes and maintain different versions of the data.
12. Data redundancy: Encoding layers can help ensure that data is not lost or corrupted during storage or transmission.
13. Easier troubleshooting: Separating data into layers can simplify identifying and resolving issues.
14. Flexibility: Layer-based architecture allows for easy adaptation to evolving user requirements or industry standards.
15. Enhanced user experience: Users can toggle between layers or combine them to create custom visualizations.
16. Efficient data storage: Bit encoding can compress data, leading to more efficient storage.
17. Consistency: Encoded layers can ensure that all users access the same information, maintaining consistency across the system.
18. Interoperability: Layer-based architecture can facilitate data exchange between different systems or applications.
19. Incremental updates: Separate layers allow for more frequent updates without affecting the entire system.
20. Future-proofing: A modular approach to data storage and access can more easily accommodate new technologies or advancements.

### ADDITIONAL EMBODIMENTS

### Embodiment of Deploying Trained Machine Learning Models to an AR Headset or Connected Devices in a Mixed Reality Environment

In this exemplar of the embodiment of deploying trained machine learning models to an AR headset or connected devices in a mixed reality environment, the following elements are included:

A trained machine learning model represents the machine learning algorithm that has been trained using the collected sensor data and intelligence mapping techniques. This model is then deployed to an AR headset or connected device, which could be a mobile device or any other connected device capable of running machine learning algorithms.

The data transfer process involves transferring the trained machine learning model from the training environment to the AR headset or connected device. This may be done through a wired or wireless connection or using cloud-based services. Once the transfer is complete, the model integration process ensures the device can access and use the model for tasks such as object recognition.

With the trained machine learning model deployed to the AR headset or connected device, real-time object identification or other machine learning tasks can be performed within the mixed reality environment. This embodiment demonstrates the seamless integration and deployment of machine learning models to enhance the capabilities of AR headsets or connected devices in mixed reality environments.

### Use Cases

The following is a non-limiting list of general uses cases for the present invention:

Autonomous vehicles (e.g., navigation, obstacle detection, and decision-making), augmented reality (e.g., accurate overlay of virtual information onto real-world environments), robotics (e.g., enhanced perception and environment understanding for robotic systems), construction (e.g., real-time monitoring and management of construction sites), architecture (e.g., improved design, planning, and visualization of building projects), urban planning (e.g., comprehensive analysis and visualization of urban environments), agriculture (e.g., precision farming, crop monitoring, and resource management), facility management (e.g., efficient maintenance and operation of large-scale facilities), environmental monitoring (e.g., tracking and analysis of environmental changes and impacts), disaster response (e.g., situational awareness and decision-making support during emergencies), infrastructure inspection (e.g., monitoring and assessment of bridges, roads, and other structures), mining (e.g., real-time monitoring and management of mining operations), oil and gas (e.g., exploration, production, and maintenance of oil and gas infrastructure), marine navigation (e.g., accurate mapping and navigation of underwater environments), forestry (e.g., resource management, conservation, and monitoring of forest ecosystems), wildlife conservation (e.g., habitat monitoring and tracking of endangered species), archaeology (e.g., advanced documentation and analysis of archaeological sites), cultural heritage preservation (e.g., accurate and detailed 3D documentation of historical sites), interior design (e.g., improved visualization and planning of interior spaces), real estate (e.g., enhanced property marketing and virtual property tours), retail (e.g., immersive and information-rich shopping experiences), tourism (e.g., interactive 3D maps for tourists to explore and navigate destinations), gaming (e.g., realistic and immersive game environments with rich contextual information), film and television (e.g., enhanced pre-visualization and special effects creation), art and design (e.g., collaborative and information-rich creative environments), industrial design (e.g., improved prototyping and visualization of products), manufacturing (e.g., streamlined production processes and quality control), logistics (e.g., efficient warehouse management and inventory tracking), defense (e.g., situational awareness and decision-making support for military operations), law enforcement (e.g., forensics and crime scene reconstruction), search and rescue (e.g., enhanced situational awareness for first responders), medical imaging (e.g., detailed and contextualized 3D visualization of medical data), surgery (e.g., preoperative planning and augmented reality assistance during surgery), sports (e.g., performance analysis and training support), telecommunications (e.g., planning and management of telecommunications infrastructure), space exploration (e.g., detailed mapping and analysis of extraterrestrial environments), transportation planning (e.g., optimized planning and management of transportation networks), power grid management (e.g., monitoring and optimization of power distribution networks), water resource management (e.g., analysis and planning of water systems and infrastructure), waste management (e.g., efficient planning and monitoring of waste disposal facilities), emergency management (e.g., enhanced preparedness and response for natural disasters and crises), traffic management (e.g., real-time monitoring and optimization of traffic flow), smart cities (e.g., integration of diverse data sources for holistic urban management), advertising (e.g., context-aware and immersive digital advertising experiences), social media (e.g., enhanced 3D content sharing and interaction), event planning (e.g., efficient planning and visualization of large-scale events), museums and galleries (e.g., interactive and information-rich exhibits), public safety (e.g., advanced monitoring and management of public spaces), home automation (e.g., smart home management and personalized experiences), aviation (e.g., improved airport operations and air traffic management), and accessibility (e.g., creation of inclusive and accessible 3D environments for users with disabilities).

The following is a non-limiting list of maintenance use cases for the present invention:

Industrial equipment maintenance (e.g., real-time monitoring, diagnostics, and guided repairs for complex machinery), building maintenance (e.g., identification and visualization of structural issues), HVAC maintenance (e.g., visualization and monitoring of systems for optimization), pipeline inspection and maintenance (e.g., accurate mapping and assessment of pipelines), electrical system maintenance (e.g., visualization and diagnosis of electrical issues), elevator and escalator maintenance (e.g., inspection and troubleshooting), bridge and infrastructure maintenance (e.g., detailed monitoring and assessment), railway maintenance (e.g., identification and assessment of track defects), wind turbine maintenance (e.g., visualization of blade damage and gearbox wear), solar panel maintenance (e.g., inspection and cleaning guidance), aircraft maintenance (e.g., detailed visualization of components), ship maintenance (e.g., identification of hull damage), vehicle fleet maintenance (e.g., real-time monitoring and guided repairs), roadway maintenance (e.g., detection and assessment of damage), telecom tower maintenance (e.g., visualization of structural issues), water treatment plant maintenance (e.g., inspection and management of components), sewer system maintenance (e.g., accurate mapping and inspection), factory and assembly line maintenance (e.g., monitoring and diagnostics), data center maintenance (e.g., visualization of server racks and cooling systems), landscape maintenance (e.g., identification of plant health issues), swimming pool and spa maintenance (e.g., inspection of filters and pumps), playground maintenance (e.g., visualization of wear and damage), amusement park ride maintenance (e.g., real-time monitoring and guided repairs), stadium and sports facility maintenance (e.g., detailed inspections of infrastructure), public transportation maintenance (e.g., inspection and management of vehicles).

The following is a non-limiting list of use cases in the computer gaming and simulation domain:

Procedural content generation (e.g., generation of terrains, buildings, and objects based on encoded information), enhanced AI behavior (e.g., more realistic navigation and interaction by AI-controlled characters), context-aware game mechanics (e.g., influencing player actions through encoded environmental information), dynamic lighting and rendering (e.g., optimization of lighting and rendering using encoded intelligence information), accessibility features (e.g., providing additional information for visually impaired players), real-time object recognition and interaction (e.g., intuitive and natural player interactions with game objects), and mixed reality experiences (e.g., seamless integration of real-world objects with virtual game elements).

The following is a non-limiting list of use cases in sports applications:

Player performance analysis (e.g., tracking and analyzing player movements and actions during games or training sessions), injury prevention and rehabilitation (e.g., analyzing movement patterns and biomechanics to identify potential injury risks and monitor rehabilitation progress), tactical analysis and decision making (e.g., providing insights into player positions, movements, and interactions for strategic decision making), fan engagement and immersive experiences (e.g., creating interactive and immersive experiences for spectators with augmented reality applications), venue and facility management (e.g., optimizing the layout and design of sports venues for efficient crowd management and facility placement), virtual sports training and simulation (e.g., integrating intelligence mapping into VR and AR systems for realistic training environments), and wearable technology and smart equipment (e.g., incorporating intelligence mapping into wearable devices for real-time performance feedback).

### INDUSTRIAL APPLICATION

The Converged Mixed Reality framework represents a significant advancement in the integration of intelligence layers into 3D models, addressing various industrial applications. This technology facilitates the detailed representation and interaction with complex systems across numerous fields, such as autonomous navigation in vehicles, augmented reality overlays, and environmental monitoring. In construction and architecture, CMR enables real-time monitoring and visualization, enhancing efficiency and decision-making. Urban planning benefits from comprehensive environment analyses, while agriculture sees improvements in precision farming and resource management.

CMR's utility extends to facility management, where it contributes to the efficient operation of large infrastructures, and to environmental monitoring, aiding in the analysis of ecological changes. It can be utilized for disaster response, infrastructure inspection, and the preservation of cultural heritage by providing enhanced situational awareness and detailed documentation capabilities. Furthermore, CMR supports a wide range of maintenance scenarios, including industrial equipment and public infrastructure, by facilitating real-time diagnostics and guided repairs.

### CITATION LIST

Milgram, Paul & Takemura, Haruo & Utsumi, Akira & Kishino, Fumio. (1994). Augmented reality: A class of displays on the reality-virtuality continuum. Telemanipulator and Telepresence Technologies. 2351. 10.1117/12.197321.

1. A computer-implemented method for encoding semantic metadata having at least one attribute into an intelligence layer having an array of texels, the steps comprising:
obtaining a 3D geometry of a space;
categorizing the semantic metadata into a plurality of categories, where each category includes a plurality of metadata elements;
assigning a field for each category, where each field is defined by a bit-length within an N-bit structure of a texel;
encoding values for each element of the semantic metadata by mapping to bitwise key-value pairs within the assigned field category;
aggregating the array of texels into the intelligence layer;
mapping the intelligence layer to the 3D geometry; and
decoding the semantic metadata corresponding to a specific 3D location in the space.

2. The method of claim 1, wherein the intelligence layer includes at least one of a point-cloud of texels, a surface area of texels, a volume of texels, and objects represented by texels.

3. The method of claim 1, wherein one of the fields contains a public key used to decode all remaining fields.

4. The method of claim 1, wherein the fields further include a unique identifier (UIDs) for the texel, facilitating identification and differentiation of texels within the intelligence layer.

5. The method of claim 1, wherein at least one of the fields serves as a reference mechanism, enabling dynamic linking to at least one of other texels within any intelligence layer, locations within system memory, and external databases and resources, the reference mechanism having at least one of pointers, Uniform Resource Identifiers (URIs), handles, and security keys (public/private keys).

6. The method of claim 1 wherein each texel is represented as a color.

7. The method of claim 1, wherein the 3D geometry is obtained via one of a 3D scanning device and a 3D geometry generation technique, including at least one of LiDAR, stereo vision cameras, structured light systems, Time-of-Flight (ToF) cameras, photogrammetry, multi-view stereo (MVS), radar, sonar, Neural Radiance Fields (NeRF), Gaussian splatting for generating and refining 3D representations, CAD models from architectural or engineering designs, Building Information Modeling (BIM) data, machine reconstructed environments, and 3D modeling programs for creating detailed virtual representations.

8. The method of claim 1, wherein the mapping of the intelligence layer to the 3D geometry utilizes at least one technique including, UV coordinates, Octree structures, Bounding Volume Hierarchies (BVH), Voxel Grids, Sparse Voxel Octrees (SVOs), Point Clouds, Neural Radiance Fields (NeRF), Gaussian splats, and corresponding a texel to a mesh.

9. The method of claim 1, wherein the texels are stored in a graphics texture and processed in parallel by a graphics processing unit (GPU) or other parallel array processor, enabling simultaneous decoding of semantic metadata across the intelligence layer.

10. The method of claim 1, wherein the value encoded within a field encompasses heterogeneous types of information, including at least one of numerical values, enumerations, binary flags, and unique identifiers including pointers, timestamps, hashes, Uniform Resource Identifiers (URIs), handles, Unique Identifiers (UIDs), and security keys.

11. The method of claim 1, wherein the aggregation of fields into texels further includes a schema that employs bitwise encoding for at least one field with key-value pairs to encode data into color space, where
each key is determined by the base 2 representation of at least one bit within the color space, mapping to a unique identifier with a specified bit range; and
a value for each key denotes a semantic element in a category relevant to the associated 3D point, surface area, volume, or object.

12. The method of claim 1, further including encoding data into a multi-layered intelligence map, wherein the intelligence map comprises layers at least one logical, observation, analysis, interaction, historical, security, customization, and composite layer, wherein each layer encodes a subset of heterogeneous data types related to the object or environment.

13. (canceled)

14. The method of claim 1, further including encoding data into the intelligence layer utilizing machine-based methods including at least one of procedural generation, data integration, direct projection, sensor position analysis, and incorporating real-time environmental data from physical sensors including Internet of Things (IoT) devices.

15. The method of claim 1, wherein positions, surface areas, volumes of space, and objects are searchable from data structures for at least one item of interest utilizing a coding schema.

16. The method of claim 1, further comprising the steps:
executing a query within the intelligence layer to identify at least one specific texel based on predefined criteria; and
upon identifying the specific texels, retrieving at least one associated field of information from any intelligence layers linked to the identified texels;
wherein the retrieved fields of information from each identified texel provide additional context, instructions, or data beyond the scope of the initial query criteria.

17. A system for converged mixed-reality having intelligence layers, the system comprising:
a mixed-reality apparatus having at least one spatial tracker that aligns the physical world to a corresponding digital representation;
a processor;
a 3D modeler, coupled to the processor, that generates and loads 3D geometry of a space for immediate use within the mixed-reality apparatus;
a mapper, coupled to the processor and the 3D modeler, that associates intelligence layers to the 3D model;
a coding schema coupled to the processor to encode semantic metadata into intelligence layers as bitwise fields within texels;
an intelligence encoder coupled to the processor and to the coding schema, wherein the intelligence layers are encoded; and
a decoder coupled to the mixed-reality apparatus and to a persistent memory, that interprets and resolves 3D locations with their associated data in the intelligence layers.

18. The system of claim 17, further including a transient memory for temporarily storing data for current mixed-reality interactions including 3D geometries and intelligence layers.

19. The system of claim 17, further including a persistent memory for storing data, including 3D geometries and intelligence layers, facilitating long-term access, retrieval, and reuse of the mixed-reality environment's components.

20. (canceled)

21. The system of claim 17, further including an integrated development environment configured to train machine learning algorithms using encoded intelligence maps.

22. The system of claim 17, further including a dynamic intelligence map update module based on at least one of user input and machine feedback.

23. The system of claim 17, further including an augmented reality interface configured to provide contextual information from intelligence layers for direct consumption by at least one of human users, autonomous systems, and machine vision systems.

24. The system of claim 17, further including:
a task management module configured to dynamically interpret intelligence layer data to identify and assign tasks within the mixed reality apparatus to human users and machines;
wherein the task management module utilizes the intelligence layer data to provide task-specific guidance and information.

25. A computer-implemented method for enhanced geospatial resolution in a Converged Mixed Reality framework integrating multi-dimensional geospatial data into texels, the steps comprising:
obtaining geospatial data, including latitude, longitude, and altitude information, and additional attributes including at least one of business listings and points of interest (POI) information from at least one source selected from a group consisting of GPS, GML (Geography Markup Language) data, KML (Keyhole Markup Language) data, GIS databases, satellite images, and LiDAR scans and custom annotations;
encoding the obtained geospatial data into a texel-based representation, where each texel is aligned with specific geographic locations on Earth's surface or volume, thereby preserving the three-dimensional integrity of the geospatial data; and
mapping the texel-based geospatial representation onto 3D models to create digital twins that accurately mirror physical world counterparts, including the assignment of lat-long coordinates to understand the model's pose.

26. The method of claim 1, wherein executing a query within the intelligence layer comprises a GPU-parallel operation across the array of texels, thereby retrieving metadata associated with multiple 3D positions simultaneously.

27. The system of claim 17, wherein the processor includes a GPU configured to perform parallel decoding and querying of texel-encoded semantic metadata across the intelligence layer.

28. The method of claim 1, wherein the aggregation of fields into texels further includes a schema that employs bitwise encoding for at least one field with key-value pairs to encode data into color space, where
each key is determined by the base 2 representation of at least one bit within the color space, mapping to a unique identifier within a specified bit range; and
a value for each key denotes a semantic element in a category relevant to the associated 3D point, surface area, volume, or object.

29. The method of claim 1, further comprising encoding data into one or more layers of an intelligence map, the layers comprising homogeneous layers that store a single category of semantic metadata and heterogeneous or composite layers that integrate fields from multiple categories.

30. The method of claim 29, wherein the layers are at least one of dynamically creatable, removable, and modifiable at runtime.

31. The method of claim 29, further including dynamically synthesizing a texture by selecting fields from multiple layers, aligning the fields into a shared bit structure, and generating a composite texture at runtime.

32. The method of claim 29, further including dynamically scaling the resolution of at least one layer, including increasing or decreasing texture resolution in selected regions, and optionally performing field remapping to encode selected subsets of metadata into fewer bits.
